(19) United States
(12) Patent Application Publication
(10) Pub. No.: US 2023/0123418 A1
(43) Pub. Date: Apr. 20, 2023

(54) METHOD FOR PLANNING A TARGET TRAJECTORY

(71) Applicant: MERCEDES-BENZ GROUP AG, Stuttgart (DE)

(72) Inventors: Uli KOLBE, Engen (DE); Alexander HECKMANN, Radolfzell (DE); Raphael RAUDENBUSCH, Tuningen (DE); Andreas SPIEKER, Stuttgart (DE); Federica FIORETTI, Schwenningen (DE); Amira ABDELLAOUI, Leonberg (DE); Dominik SIXT, Stuttgart (DE); Simon SCHÄFER, Stuttgart (DE)

(21) Appl. No.: 17/915,643

(22) PCT Filed: Mar. 1, 2021
(86) PCT No.: PCT/EP2021/054976

§ 371 Date: Sep. 29, 2022

(30) Foreign Application Priority Data
Mar. 31, 2020 (DE) 10 2020 108 857.4

(51) Int. Cl. B60W 60/00

(52) U.S. Cl. CPC B60W 60/0011

(57) ABSTRACT

A method for planning a target trajectory for an autonomously operated vehicle to be travelled along involves determining a discrete set of trajectories as candidates for the target trajectory. Each of the trajectories is composed of a plurality of trajectory sections arranged in a row. The planning is based on a selection of one of the trajectories as a target trajectory. The selection is based on evaluation of the trajectories together with predefined cost functions and an identification of the trajectory evaluated as being the most cost effective. An array of sub-trajectories, each having the same location specifications and different dynamics specifications, is associated with each trajectory section, and costs in accordance with the predefined cost functions are associated with the sub-trajectories. When a change in boundary conditions to be complied with and/or in driving tasks to be performed is detected, pilot control of the selection is performed, by adapting the cost functions for the individual sub-trajectories to the changed boundary conditions and/or driving tasks, in order to allocate lower costs to the sub-trajectories better suited than other sub-trajectories to complying with the changed boundary conditions and/or to performing the changed driving tasks.

### BACKGROUND AND SUMMARY OF THE INVENTION

Exemplary embodiments of the invention relate to a method for planning a target trajectory.

DE 10 2015 208 790 A1 discloses a method and a system for automatically determining a trajectory for a vehicle. The trajectory connects a starting point, which corresponds to the current position of the vehicle, to a target point. In the method, a plurality of intermediate points are determined, wherein, in addition, at least one first sub-trajectory is determined that connects the starting point to one of the intermediate points. Furthermore, a plurality of second sub-trajectories are determined, which in each case connect the target point to one of the intermediate points. In addition, the trajectory is determined by selecting one of the at least one first sub-trajectory and one of the second sub-trajectories, and at least one component of the vehicle is controlled based on the basis of the determined trajectory, wherein at least two sub-trajectories end at each intermediate point.

WO 2019/223909 describes a method for the at least partially automated control of a motor vehicle. The method comprises receiving surroundings signals representing a surrounding environment of the motor vehicle that is detected by means of surroundings sensors of the motor vehicle. In the case of an object situated in front of the motor vehicle in relation to a direction of travel of the motor vehicle being detected on the basis of the received ambient signals. Furthermore, the method provides determining whether a road junction lies within an overtake trajectory for overtaking the object and whether any oncoming traffic in relation to the motor vehicle will be blocked for the duration of the overtake. If the determination has revealed that there is no road junction lying within an overtake trajectory for overtaking the object and that no oncoming traffic will be blocked for the duration of the overtake, control signals for the at least partially automated control of a transverse and longitudinal guidance of the motor vehicle, on the basis of the overtake trajectory, are then output.

Exemplary embodiments of the invention are directed to an improved method for planning a target trajectory, which should be travelled along by the vehicle in an automated manner.

A method for planning a target trajectory to be travelled along in an automated manner by a vehicle provides that a discrete set of trajectories are determined as candidates for the target trajectory, wherein each of these trajectories is composed of a plurality of trajectory sections arranged in a row. The method furthermore provides that the planning is based on a selection of one of the trajectories as a target trajectory, wherein the selection is based on an evaluation of the trajectories together with predefined cost functions and an identification of that trajectory that has been evaluated as being the most cost effective. According to the invention, an array of sub-trajectories, each having the same location specifications and different dynamics specifications, is associated with each trajectory section. In this context, location specifications are to be understood as specifications relating to the location path that the vehicle should follow when travelling along the respective trajectory section, and dynamics specifications are to be understood as specifications relating to the dynamics of the vehicle, in particular specifications relating to the acceleration and/or speed, with which the vehicle should move when travelling along the respective trajectory section. When a change in boundary conditions to be complied with and/or in driving tasks to be performed is detected, pilot control of the selection is carried out, by adapting the cost functions for the individual sub-trajectories to the changed boundary conditions and/or driving tasks, in order to allocate lower costs to sub-trajectories which are better suited than others to complying with the changed boundary conditions and/or to performing the changed driving tasks.

By applying the method, the vehicle driving in an automated manner can carry out different driving tasks, wherein it can be ensured as far as possible that the driving tasks are only carried out if there is no breach of safety-critical criteria.

The driving tasks comprise, in particular, forming an emergency lane, reducing the driving speed of the vehicle in certain driving situations as a preventative measure, switching lanes because of certain vehicles, such as, e.g., the police and/or emergency services, parking the vehicle on a hard shoulder, and/or taking into account a degradation in a steering or braking system of the vehicle.

The method makes it possible for a vehicle driving in an automated manner to carry out different driving tasks by targeted pilot control of the target trajectory planning in real time. If there is the risk that safety limits will be infringed by performing a driving task, the target trajectory planning can override a specification and provide a safer target trajectory.

In one embodiment of the method, each trajectory, determined as candidate, and therefore also the target trajectory selected from the set of these candidates, as dataset, comprises information about a location path that the vehicle should follow when travelling along the respective trajectory, and also further information about the dynamics, in particular about an acceleration and/or driving speed, with which the vehicle should move when travelling along the respective trajectory. By means of the target trajectory selected from the set of trajectories, it is therefore not only determined along which location coordinates the vehicle should drive in the automated driving mode, but it is also specified how dynamically the vehicle should move, i.e., at which points in time should the vehicle be at the respective location coordinates. The method thus makes it possible to find an optimum location path for the automated vehicle guidance and at the same time to find optimum vehicle dynamics.

In addition, in a further embodiment, the set of trajectories, from which the target trajectory is selected, is discretized, by determining a predetermined set of trajectory support points as possible whereabouts of the vehicle in a predefinable look-ahead horizon by selecting, from the set of trajectory support points, a plurality of rows of points running in the direction of travel and by determining the trajectories in such a way that they each run through one of the rows of points. In other words: the trajectory support points represent positions within the look-ahead horizon, through which in each case one or more of the trajectories are guided. Each of the trajectories is accordingly guided through a predefined set of trajectory support points, wherein the sections between two trajectory support points form the aforementioned trajectory sections, with each of which the aforementioned array of sub-trajectories is associated. The individual trajectories are thus composed of sub-trajectories, each of which are connected to one another at one of the trajectory support points. Due to the limited number of sub-trajectories, the number of trajectories composed thereof is also limited. The set of trajectories is referred to below as trajectory array. Since the planning of the target trajectory is based on the selection of a trajectory from the trajectory array, the target trajectory can be planned with little computational outlay.

In one possible development, for each trajectory of the trajectory array, costs are ascertained using the predefined cost function, wherein the cost functions for the individual trajectory sections and the sub-trajectories associated with each of these are defined as a function of the boundary conditions to be complied with or the driving tasks to be performed. The cost functions thus take into account boundary conditions, such as, for example, that the target trajectory to be selected must not leave a lane of the vehicle driving in an automated manner and that the target trajectory can be realized physically for the vehicle driving in an automated manner.

In one possible development of the method, separate cost functions, defined for the various boundary conditions or driving tasks, are respectively predefined for the various sub-trajectories of the individual trajectory sections. These cost functions indicate how well a respective boundary condition or driving task can be fulfilled in respect of the target trajectory. Comparatively good fulfilment is rewarded with low costs and comparatively poor fulfilment is penalized with high costs.

Advantageously, total costs are ascertained for each of the trajectory sections by summing the costs associated with the sub-trajectories of the respective trajectory section in weighted fashion.

The costs of a trajectory are advantageously ascertained by summing the total costs of its trajectory sections.

In another possible embodiment, in order to determine the comparatively best target trajectory, total costs of a trajectory section are ascertained by means of a weighted summation of the costs, determined for the various boundary conditions, of a trajectory section.

Subsequently, in one possible embodiment, costs of a trajectory are ascertained by summing the total costs of its trajectory sections, wherein the trajectory is selected, as target trajectory which the vehicle driving in an automated manner travels along, from the trajectory array which, taking the boundary conditions and/or driving tasks into account, has the lowest costs.

The method furthermore provides that the cost functions are modified by means of a pilot control, wherein, by means of the pilot control, the trajectory planning is adapted to a current driving task and a prioritization is carried out in the case of a plurality of driving tasks. The aim of the pilot control is to adapt the planning of the trajectories, in particular the selection of the target trajectory, to a current driving task including the required boundary conditions, and to carry out the prioritization in the case of a plurality of driving tasks. The target trajectory is therefore selected by taking into account the current driving task or, if appropriate, multiple compatible driving tasks to be taken into account.

### BRIEF DESCRIPTION OF THE DRAWING FIGURES

Exemplary embodiments of the invention will be explained in more detail hereunder using the drawings.

In the drawings:

FIG. 1 schematically shows a first step for determining a trajectory array,

FIG. 2 schematically shows a second step for determining a trajectory array,

FIG. 3 schematically shows a third step for determining a trajectory array,

FIG. 4 schematically shows a cost function,

FIG. 5 schematically shows a modification of a cost function by pilot control, and

FIG. 6 schematically shows a modification of a further cost function by pilot control.

Mutually corresponding parts are provided with the same reference numerals in all of the figures.

### DETAILED DESCRIPTION

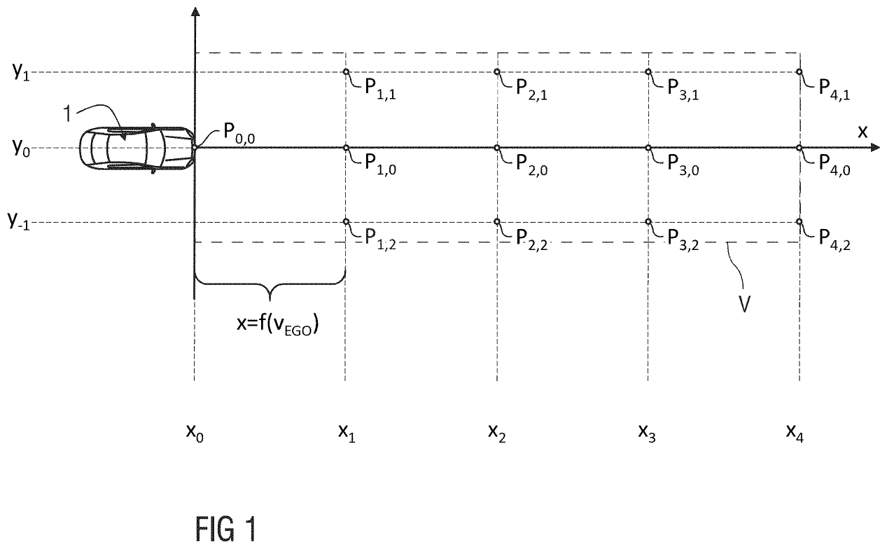

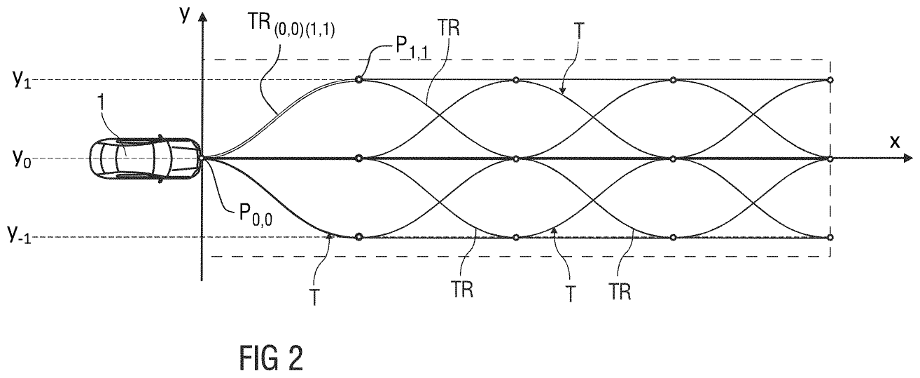

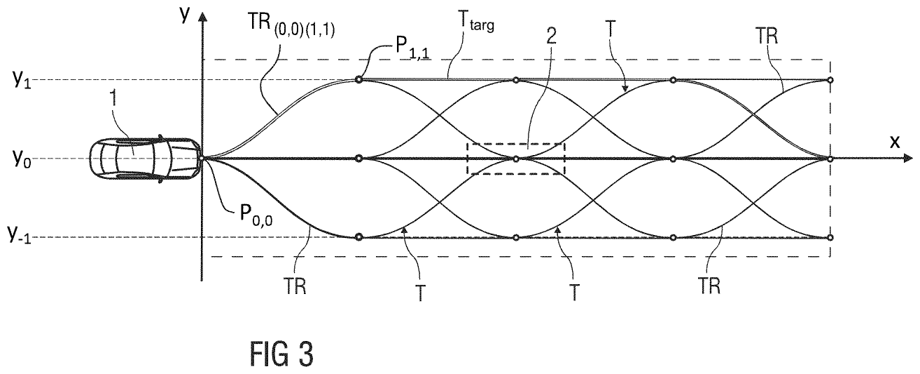

FIG. 1 illustrates a first step for determining a trajectory array from which a trajectory T, shown inter alia in FIG. 2, is selected as target trajectory T_{targ} which is shown in more detail in FIG. 3.

A vehicle 1 has an assistance system for the automated driving mode, whereby signals are continuously detected during the automated driving mode by means of a corresponding sensor system.

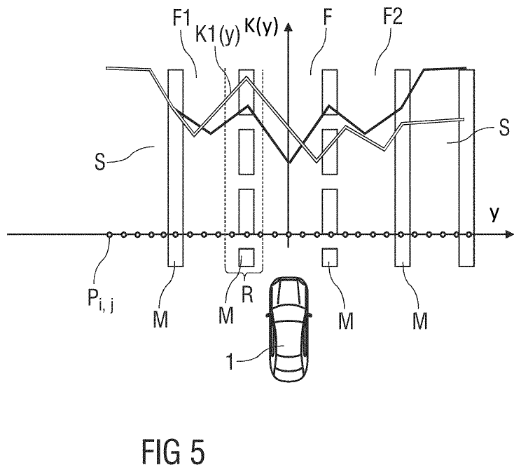

When the vehicle 1 is in the automated driving mode, it is necessary for the vehicle 1 to behave adequately in a variety of driving situations and to fulfil different driving tasks. In a normal automated driving mode, these driving tasks comprise, e.g., keeping distance in the middle of a lane, complying with a set speed, wherein special driving tasks are understood to mean, for example, forming an emergency lane R shown in FIG. 5 or changing lanes, up to avoiding a collision, for example because an obstacle has suddenly been detected in a lane F of the vehicle 1.

To detect the various driving situations, the sensor system comprises a multiplicity of sensors arranged in and/or on the vehicle 1 that are optionally consolidated in order to check the plausibility of detected signals for example and/or to extend or optimize a detection range.

In order to be able to control a multiplicity of possible driving situations in the automated driving mode of the vehicle 1, a trajectory planning model is typically used that either selects a best trajectory T from a multiplicity of possible trajectories T or computes an optimum trajectory T using an optimization method.

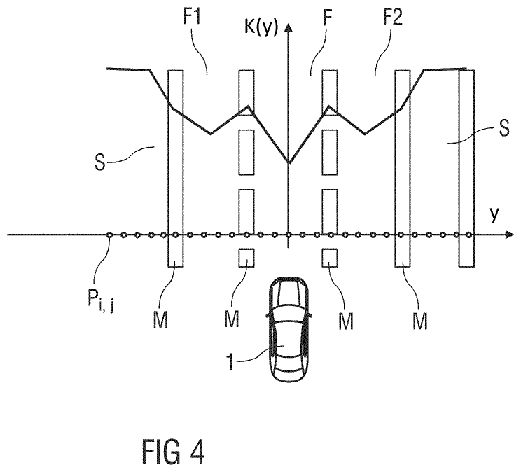

Both of these approaches are based on evaluating trajectories T by means of cost functions K, shown in particular in FIGS. 4 to 6, wherein the costs are made up of different partial costs with different weightings.

Examples of individual cost functions K are:
deviating from a desired path,
high level of vehicle dynamics in the longitudinal and transverse direction of the vehicle 1,
dropping below a safety distance,
colliding with an obstacle 2 (shown in more detail in FIG. 3),
not complying with set speeds, etc.

In order to ensure a comparatively safe automated driving mode of the vehicle 1, the safety-critical costs are given a higher weighting than costs that arise due to an uncomfortable ride.

When selecting trajectories T, it is necessary to additionally comply with so-called hard boundary conditions, wherein the trajectory T is not allowed to leave a lane and it must be possible to physically realize the trajectory T.

In order to control the multiplicity of different special driving tasks, a method described below is provided, wherein a trajectory planning is controlled by changing target states and manipulated variable ranges of the vehicle 1.

The trajectory planning then plans the specifications for a pilot control if no higher, fundamental objectives are infringed in the process, such as for example dropping below a safety distance until a collision occurs, an unintentional departure from the lane F, an excessive vehicle reaction or even non-drivability.

If, for example, a collision of the vehicle 1 with an obstacle 2 is imminent due to the obstacle 2 suddenly appearing in front of the vehicle 1, avoiding the collision takes priority over a driving task. If such a critical situation no longer exists, the desired driving task is again given priority.

The method provides continuous specifications for trajectory planning by a maximally permissible driving speed v_{EGO}, also in connection with a predefined distance and/or time, a desired offset of the vehicle 1 with respect to the center of its lane F, also in connection with the predefined distance and/or time, an adjustable deceleration, a permissible acceleration, and adjustable steering dynamics.

In addition, the method comprises prioritizing possibly incompatible driving tasks. For example, a system for the automated driving mode of the vehicle 1 can request a safe parking of the vehicle 1, while at the same time a so-called move-over-law situation exists, which requires a different reduction in speed.

Behavior in a move-over-law situation, i.e., when an evasive action rule applies, e.g., when an emergency vehicle, for example, a police car, is approaching, can also require a different offset within the lane F of the vehicle 1 than is required to form an emergency lane R.

In both cases, the driving task is prioritized by a choice of a driving speed and/or offset specification with respect to a positioning of the vehicle 1 within its lane F.

In addition, the method provides that specific driving tasks be required to change the specifications of the cost functions K in the trajectory planning, such as e.g.:
safe parking of the vehicle 1 on a hard shoulder S shown by way of example in FIG. 4,
a lane change,
a preventative reduction in a driving speed v_{EGO} in an uncertain driving situation, e.g., when a vehicle is travelling against the flow of traffic in an adjacent lane or there is a pedestrian on the roadway,
reduction in the current driving speed v_{EGO} and at the same time driving to an edge of the lane F if a move-over-law situation exists, etc.

More complex driving tasks, such as safely parking the vehicle 1 on the hard shoulder S or a multiple lane change, are conveyed to the trajectory planning by a temporal sequence of driving speed and offset specifications, so-called lane offset specifications.

If a degraded state of a braking or steering system is reported, an adjustable braking or steering dynamic is adapted to the trajectory planning.

In addition, an adjustable deceleration of the vehicle 1, i.e., a reduction in the current driving speed V_{EGO}, is adapted to prevailing weather conditions.

In particular, the method provides that a target trajectory T_{targ}, illustrated by way of example in FIG. 3, that should be travelled along by the vehicle 1 in the automated driving mode, in particular without a driver.

Such a target trajectory T_{targ} is to be understood to mean a dataset containing information about a location path, i.e., location coordinates, that the vehicle 1 should follow when travelling along the target trajectory T_{targ}, and comprises information about an acceleration or driving speed v_{EGO} at which the vehicle 1 should move when travelling along the target trajectory T_{targ}. The target trajectory T_{targ} thus not only specifies which location coordinates the vehicle 1 should travel to but also at which times the vehicle 1 is located at the respective location coordinates.

The planning is based in this case on determining a discrete set of candidates for the target trajectory T_{targ}, wherein the selection is based on cost functions K as described above and known from the prior art.

FIG. 1 shows a coordinate system in detail, wherein x coordinates x₁ to x₄ are plotted on an x axis in a vehicle longitudinal direction, i.e., in the direction of travel of the vehicle 1 driving in an automated manner, and y coordinates y₋₁ to y₁ are plotted on the y axis and denote a vehicle transverse direction. Δx, i.e., a distance between two x coordinates, describes a function of a current driving speed v_{EGO} of the vehicle 1.

In addition, a multiplicity of trajectory support points P_{0,0} to P_{4,2} are illustrated, wherein the trajectory support point P0,0 represents a starting point of the vehicle 1 and the trajectory support points P_{4,0} to P_{4,2} represent the destination coordinates of the vehicle 1. In particular, the x coordinates x₀ to x₄ and the y coordinates y₋₁ to y₁ are the x-y coordinates of the trajectory support points P=(xᵢ, yⱼ).

The trajectory support points P_{0,0} to P_{4,2} are distributed in the x-axis direction, i.e., in the direction of travel of the vehicle 1 over a look-ahead horizon V. This look-ahead horizon V defines a route that the vehicle 1 will pass, i.e., travel along, at its current driving speed v_{EGO} within a predefined time interval, for example 30 seconds. Within the look-ahead horizon V, an infinite number of trajectories, from which a target trajectory T_{targ} can be selected, is possible in theory. To minimize the computational effort required when selecting the target trajectory T_{targ} best suited to the vehicle 1 and a driving situation, the set of trajectories, from which the target trajectory T_{targ} should be selected, is discretized. For this purpose, a predetermined set of trajectory support points P_{0,0} to P_{4,2} is determined in the look-ahead horizon V, as is shown in FIG. 1, and a set of trajectories T is determined, each of which runs in the direction of travel through a series of trajectory support points P_{0,0} to P_{4,2}, as illustrated in a second step, shown in FIG. 2, for determining a trajectory array in a further coordinate system.

This set of trajectories T forms a trajectory array, wherein the trajectories T form the coordinates for the selection of the target trajectory T_{targ}, i.e., only this limited number of trajectories T is taken into account for the selection of the target trajectory T_{targ}.

In particular, individual trajectory support points P_{0,0} to P_{4,2}, as shown in FIG. 2, are connected to each other in pairs in the x direction, i.e., in the direction of the vehicle longitudinal axis, according to their order in the direction of travel. As a result, individual trajectory sections TR, TR_{(0,0)(1,1)} of the trajectories T are formed, which are associated with a set from which a target trajectory T_{targ} illustrated in FIG. 3 is selected.

Each trajectory section TR, TR_{(0,0)(1,1)} itself comprises an array of sub-trajectories, not shown in more detail, each with the same x-y paths but different accelerations and/or speeds. Costs are associated with the sub-trajectories, wherein the costs are associated using cost functions K that have been predefined for the different boundary conditions.

When a change in boundary conditions to be complied with or in driving tasks to be performed is detected, pilot control of the selection is carried out, by adapting the cost functions K for individual sub-trajectories of the individual trajectory sections TR, TR_{(0,0)(1,1)} to the changed boundary conditions. This adaptation is carried out in order to allocate lower costs to sub-trajectories and trajectory sections TR, TR_{(0,0)(1,1)} that are better suited than others to complying with changed boundary conditions and/or to performing changed driving tasks.

For each trajectory T from the trajectory array, costs are determined by means of predefined cost functions K, wherein the cost functions are defined for the individual sub-trajectories of the individual trajectory sections TR_{(0,0)(1,1)} of a trajectory T and for predefined boundary conditions, and indicate how well the respective boundary conditions are fulfilled on the respective trajectory section TR_{(0,0)(1,1)} with the respective sub-trajectory.

Comparatively good fulfilment is rewarded with low costs, whereas comparatively poor fulfilment is penalized with high costs. Based on a, in particular weighted, summation of the costs, determined for the various boundary conditions, of a sub-trajectory of a trajectory section TR_{(0,0)(1,1)}, the total costs of a trajectory section TR_{(0,0)(1,1)} are ascertained.

The costs of a trajectory T of the trajectory array are formed by summation of the total costs of the trajectory sections TR_{(0,0)(1,1)} of the respective trajectory T. The trajectory T having the lowest costs is then selected from the trajectory array as the target trajectory T_{targ}, as shown in FIG. 3.

The target trajectory T_{targ} selected from the trajectory array shows a travel path of the vehicle 1 due to the obstacle 2 in its lane F, which obstacle is detected in the look-ahead horizon V.

The trajectory sections TR leading to a collision of the vehicle 1 with the obstacle 2 are sanctioned by increasing their costs. This results in a lower priority being given to these trajectory sections TR for the selection of the target trajectory T_{targ} than to the other trajectory sections TR.

FIGS. 4 to 6 each show an example of a cost function.

FIG. 4 shows a cost function K(y) for a transverse position of the vehicle 1, wherein a lane F of the vehicle 1, a left-hand lane F1, a right-hand lane F2, lane markings M, a respective hard shoulder S or side strip and trajectory support points P_{i,j}=(xᵢ,yⱼ) are illustrated.

The vehicle 1 driving in the center of its lane F is associated with lower costs than if the vehicle 1 were not driving in the center. In other words, driving in the center of its lane F is rewarded with lower costs.

The vehicle 1 driving on the lane markings M is sanctioned by high costs and driving in the center of the left-hand lane F1 or of the right-hand lane F2 is sanctioned more than driving in the center of the lane F of the vehicle 1 and is sanctioned less than driving on the lane markings M. Using the hard shoulder S or side strip has comparatively severe sanctions and is penalized with correspondingly high costs.

FIG. 5 firstly shows a progression of the cost functions K(y) illustrated in FIG. 4 and a cost function K1(y) modified by means of the pilot control and its progression.

The aim of the pilot control is to adapt the trajectory planning for the selection of the target trajectory T_{targ} to a required driving task and required boundary conditions and to carry out a prioritization if there are several driving tasks to be performed. The target trajectory T_{targ} is therefore selected by taking into account the current driving task or, if appropriate, multiple current driving tasks to be taken into account.

According to the exemplary embodiment shown in FIG. 5, in order to form an emergency lane R, driving the vehicle 1, offset with respect to the center of the lane, within its lane F is rewarded more greatly by lower costs than driving in the center of the respective lane F, F1, F2.

Driving in the right-hand lane F2 is rewarded more greatly by lower costs and driving in the emergency lane R is sanctioned by higher costs.

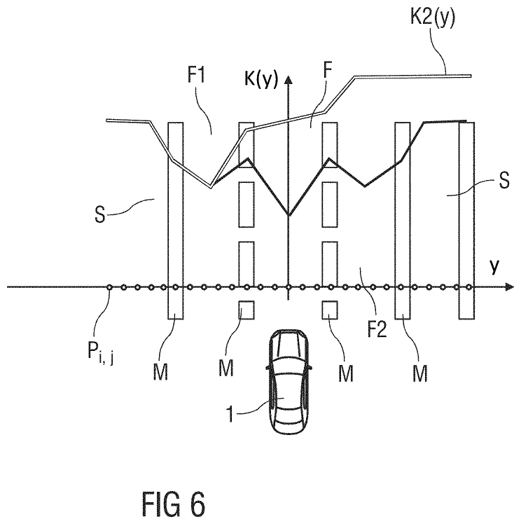

FIG. 6 shows a further exemplary embodiment for a pilot control, wherein the cost functions K(y) and a modified further cost function K2(y) are illustrated.

Driving in the right-hand lane F2, for example because there is an accident in the right-hand lane F2, is sanctioned comparatively highly, wherein driving in the lane F of the vehicle 1 is likewise sanctioned in order not to endanger rescue services on duty at the scene of the accident.

In an analogous manner, cost functions K that are predefined for other driving tasks and/or other boundary conditions to be complied with can also be modified. The modification achieves pilot control for the trajectory selection.

A driving task for the vehicle 1 can require, for example, that an additional offset to the center of the corresponding lane F, F1, F2 be complied with, e.g., so as to form an emergency lane R or to increase a lateral distance from certain classes of objects, such as lorries, tunnel walls, bridge piers, guide walls.

Furthermore, a driving task can require that, as described further above, a certain maximally permissible speed be complied with, that longitudinal dynamics, in particular an adjustable deceleration or a permissible acceleration, or transverse dynamics, in particular steering dynamics in the form of a yaw rate, a steering angle speed and/or a transverse acceleration, be limited to certain values that can be predefined depending on the situation, for example as a function of weather conditions, a driving speed v_{EGO}, a curve in the road and/or a degradation of a steering or braking system of the vehicle 1.

In addition, it may be required as a driving task to park the vehicle 1 on a hard shoulder S, e.g., if the steering or braking system is degraded, that the driving speed is reduced preventively, e.g., in the event of an accident, with police, emergency services, pedestrians being on the roadway, vehicles travelling against the flow of traffic on correspondingly adjacent lanes F, F1, F2.

Furthermore, a driving task can specify that certain lanes F, F1, F2 be avoided, e.g., the lane F, F1, F2 next to police and emergency services parked at the site of an incident, i.e., even in the event of the so-called move-over-law situation, and in the case of pedestrians or vehicles travelling against the flow of traffic.

Furthermore, one driving task worth noting can be for the vehicle 1 to perform a lane change, e.g., to avoid lanes F, F1, F2, to circumvent obstacles 2, to overtake comparatively slower road users, to control the vehicle 1 in a filter lane or slip road.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method for planning a target trajectory to be travelled along in an automated manner by a vehicle, the method comprising:
determining a discrete set of trajectories as candidates for the target trajectory, wherein each trajectory of the discrete set of trajectories is composed of a plurality of trajectory sections arranged in a row; and
planning the target trajectory by selecting one of the trajectories of the discrete set of trajectories,
wherein the selection of the one of the trajectories of the discrete set of trajectories is based on an evaluation of each trajectory of the discrete set of trajectories together with predefined cost functions and an identification of the one of the trajectories of the discrete set of trajectories as being the most cost effective,
wherein a plurality of sub-trajectories, each having a same location specification and different dynamics specifications, is associated with each of the plurality of trajectory sections, and costs according to the predefined cost functions are associated with each sub-trajectory, and
wherein, when a change in boundary conditions to be complied with or in driving tasks to be performed is detected, pilot control of the selection of the one of the trajectories is performed by adapting the cost functions for the individual sub-trajectories to the changed boundary conditions or driving tasks to allocate lower costs to sub-trajectories that are better suited than sub-trajectories to complying with the changed boundary conditions or to performing the changed driving tasks.

11. The method of claim 10, wherein each of the trajectories of the discrete set of trajectories, as dataset, comprises information about a location path that the vehicle should follow when travelling along the respective trajectory, and also contains further information about dynamics with which the vehicle should move when travelling along the respective trajectory.

12. The method of claim 10, wherein the discrete set of trajectories, from which the target trajectory is selected, is discretized, by determining a predetermined set of trajectory support points as possible whereabouts of the vehicle in a look-ahead horizon by selecting, from the set of trajectory support points, a plurality of rows of points running in a direction of travel and by determining the sub-trajectories of the discrete set of trajectories in such a way that they each run through one of the selected rows of points.

13. The method of claim 10, wherein, for each of the trajectories of the discrete set of trajectories, costs are determined using the predefined cost functions.

14. The method of claim 10, wherein the cost functions for individual trajectory sections of the plurality of trajectory sections and the sub-trajectories associated with each of the individual trajectory sections are predefined as a function of the boundary conditions to be complied with or the driving tasks to be performed.

15. The method of claim 10, wherein the costs associated with the sub-trajectories of a trajectory section are summed in weighted fashion to determine total costs of the respective trajectory section.

16. The method of claim 15, wherein costs of a trajectory of the discrete set of trajectories are determined by summing the total costs of trajectory sections of the respective trajectory of the discrete set of trajectories.

17. The method of claim 13, wherein a trajectory having lowest costs is selected from the set of trajectories as the target trajectory.

18. The method of claim 10, wherein the cost functions are modified by the pilot control so that the trajectory planning is adapted to a current driving task and a prioritization is performed when there are a plurality of driving tasks.
